(19) United States
(12) Patent Application Publication
(10) Pub. No.: US 2016/0282049 A1
(43) Pub. Date: Sep. 29, 2016

(54) METHOD FOR DETERMINING THE STATE OF A REFRACTORY LINING OF A METALLURGICAL VESSEL FOR MOLTEN METAL IN PARTICULAR

(71) Applicant: REFRACTORY INTELLECTUAL PROPERTY GMBH & CO. KG, Wien (AT)

(72) Inventors: Gregor LAMMER, Wien (AT); Christoph JANDL, Linz (AT); Karl-Michael ZETTL, Wien (AT)

(73) Assignee: REFRACTORY INTELLECTUAL PROPERTY GMBH & CO.KG, Wien (AT)

(21) Appl. No.: 14/777,810

(22) PCT Filed: Mar. 7, 2014
(86) PCT No.: PCT/EP2014/054474

§ 371 Date: Sep. 17, 2015

(30) Foreign Application Priority Data
Apr. 12, 2013 (EP) 13163565.8

(51) Int. Cl. F27D 21/00; F27D 1/16

(52) U.S. Cl. CPC F27D 21/0021; F27D 1/16; F27D 2001/0046

(57) ABSTRACT

The invention relates to a method for determining the state of a fire-resistant lining of a vessel (10) containing molten metal in particular. In the process, maintenance data, production data, and wall thicknesses at least at locations with the highest degree of wear are measured or ascertained together with additional process parameters of a vessel (10) after the vessel (10) has been used. Said data is then collected and stored in a data structure. A calculating model is generated from at least some of the measured or ascertained data or parameters, and said data or parameters are evaluated by means of the calculating model using calculations and subsequent analyses. Thus, related or integral ascertaining processes and subsequent analyses can be carried out, on the basis of which optimizations relating to both the vessel lining as well as the complete process of the molten metal in the vessel are achieved.

The invention relates to a method for determining the state of a refractory lining of a metallurgical vessel, preferably a vessel for molten metal, in particular, according to the preamble to claim 1.

Calculation methods exist for the construction of the refractory lining in particular of metallurgical vessels for molten metal, wherein ascertained data or empirical values are converted into mathematical models. Since with these mathematical models the effective wear mechanisms for the uses of the metallurgical vessels can not be detected sufficiently accurately or be taken into consideration, the possibilities for mathematically determining the refractory constructions and the maintenance work for the lining are very restricted, i.e. decisions regarding the period of use of the refractory lining of a vessel, for example of a converter, must still be taken manually.

In a method according to publication WO-A-03/081157 for measuring the residual thickness of the refractory lining in the wall and/or base area of a metallurgical vessel, e.g. of an arc furnace, the measured data ascertained are used for the subsequent repair of the areas of wear that have been identified. The measuring unit is brought here on a manipulator serving to repair the lining into a measuring position over or inside the metallurgical vessel and the residual thickness of the lining is then measured in its wall and/or base area. By comparing with a current profile of the lining measured at the start of the furnace campaign its wear is ascertained, on the basis of which the refractory lining can then be repaired. With this method, however, comprehensive ascertainment of the vessel lining is not possible either.

According to publication WO-A-2007/107242 a method for determining the wall thickness or the wear of the lining of a metallurgical crucible with a scanner system for contactlessly sensing the lining surface with determination of the position and orientation of the scanner system and assignment to the position of the crucible by detecting spatially fixed reference points is disclosed. A perpendicular reference system is used here and the tilts of two axes in relation to a horizontal plane are measured by means of tilt sensors. The data measured by the scanner can be transformed into a perpendicular coordinate system and automated measurement of the respective current state of the lining of the crucible is thus possible.

On the basis of these known calculation methods or measuring methods it is the object of the present invention to devise a method by means of which the service life of the refractory lining of a metallurgical vessel and the process in its own right can be optimised and manual decisions for this purpose are reduced or practically eliminated.

According to the invention this object is achieved by the features of claim 1.

The method according to the invention makes provision such that all of the data of a respective vessel are collected and stored in a data structure, and a calculation model is generated from all of the measured and ascertained data or parameters, by means of which these data or parameters are evaluated by means of calculations and subsequent analyses.

With this method according to the invention, for a metallurgical vessel one can ascertain not only measurements in order to identify the current state of the vessel after it has been used, but related or integral ascertaining processes and subsequent analyses can also be carried out from which optimisations are achieved both in relation to the vessel lining and to the entire process sequence of the molten mass poured into the vessel and treated within the latter.

Additional advantageous details of this method within the framework of the invention are defined in the dependent claims.

Exemplary embodiments as well as additional advantages of the invention are described in more detail below by means of a drawing. This shows:

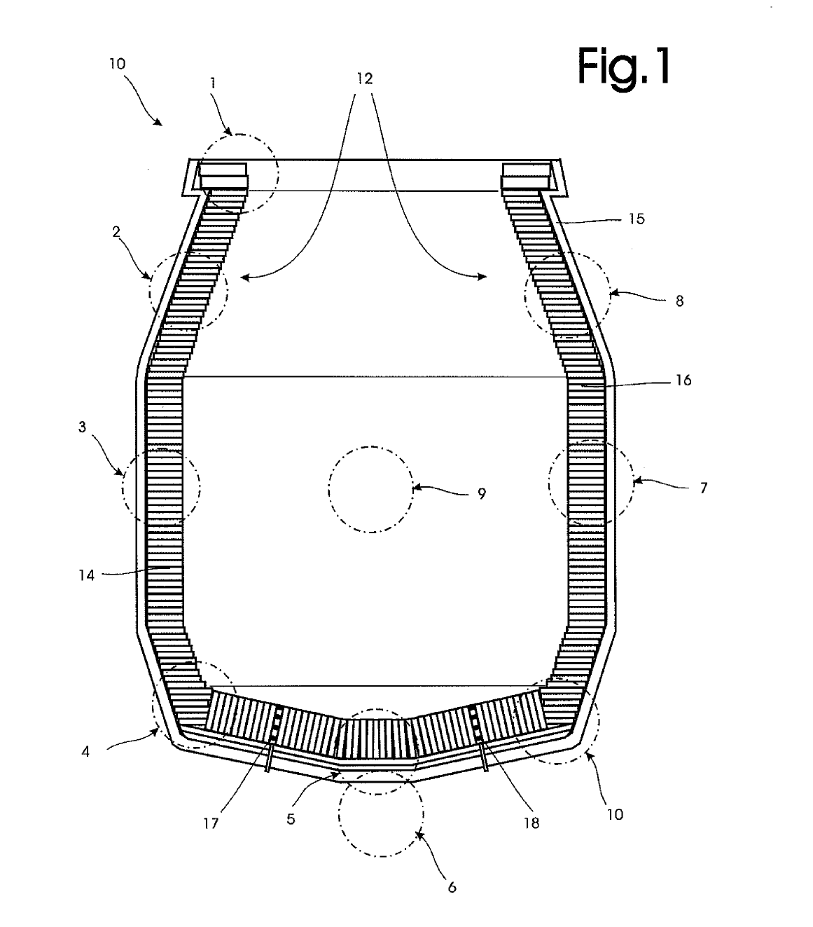

FIG. 1 is a diagrammatic longitudinal section of a metallurgical vessel sub-divided into sectors.

The method relates in particular to metallurgical vessels, one such vessel 10 being shown in section in FIG. 1 as an exemplary embodiment. In this instance the vessel 10 is a converter, known in its own right, for the production of steel. The vessel 10 consists essentially of a metal housing 15, a refractory lining 12 and gas purging plugs 17, 18 which can be coupled to a gas supply (not detailed).

The molten metal which is poured into this vessel 10 during operation is treated metallurgically, for example by a blowing process which will not be described in any more detail. Generally a number of these converters 10 are used at the same time in a steel works and data are to be recorded for each of these converters.

Needless to say, the method can be used for different metallurgical vessels, such as for example for electric furnaces, blast furnaces, steel ladles, vessels in the field of non-ferrous metals such as aluminium melting furnaces, copper anode furnaces or the like.

The method is also characterised in that it can likewise be used for different containers. Thus, for example, the refractory linings of all converters and ladles in operation can be determined, wherein the same molten mass is first of all treated in a converter and is then poured into steel ladles.

First of all, all of the data for each vessel 10, sub-divided into groups, are collected and stored in a data structure.

In order to measure the wear as a group of the vessel lining 12 embedded within the metal housing 15, this initially takes place on the new refractory lining which is generally provided with different blocks 14, 16 or wall thicknesses. This can also take place by measuring or by the pre-specified dimensions of the blocks 14, 16 being known. In addition, the materials and material properties of the blocks 14, 16 used and of any injected materials used are recorded.

For the additional group identified as production data recording takes place during the period of use of the respective vessel 10, such as the amount of molten mass, the temperature, the composition of the molten mass or the slag and its thickness, tapping times, temperature profile, treatment time and/or metallurgical parameters such as particular additions to the molten mass. Depending on the type of vessel, only some or all of the aforementioned production data are recorded.

Furthermore, after using a vessel 10 a measurement of the wall thicknesses of the lining 12 is then taken, at least at the points with the greatest wear, for example at the contact points of the slag when the vessel is full, but preferably of the entire lining 12. It is sufficient here if the wall thicknesses of the lining 12 are measured after a number of tappings.

Other process parameters, such as the manner of pouring or tapping the molten metal into or out of the crucible can then be ascertained.

According to the invention, a calculation model is generated from at least some of the measured and ascertained data or parameters, by means of which these data or parameters are evaluated by calculations and subsequent analyses.

By means of this calculation model generated according to the invention the maximum period of use, the wall thicknesses, the materials and/or the maintenance data of the refractory lining 12 or, conversely, the process sequences for the treatment of the molten mass can be optimised. From these analyses a decision can sometimes be made here regarding further use of the lining with or without repairs. One no longer requires, or if so only to a limited extent, manual experiential interpretation of the period of use of the lining 12 and of the other values to be determined, such as wall thicknesses, material selection etc.

Advantageously the metallurgical vessel 10, such as for example a converter, is sub-divided into different sections 1 to 10, sections 1, 2, 8 being assigned to the upper vessel part, sections 3, 7, 9 being assigned to the side vessel part, and sections 4, 5, 6 being assigned to the vessel base.

Sections 1 to 10 are evaluated individually or independently of one another with the calculation model. The advantage of this is that the different loads of the lining in the vessel base, the side walls or in the upper vessel part can be correspondingly taken into account.

Before or during generation of the calculation model the data are checked for plausibility after being recorded and if there is a lack or an anomaly of one or more values, the latter are respectively corrected or deleted. After preferably individually checking the data, the latter are stored as an assembled, valid set of data.

Advantageously, a reduced number is selected from the measured or ascertained data or parameters for the recurring calculations or analyses, this taking place dependently upon empirical values or by calculation methods. This selection of measured or ascertained data or parameters for the recurring calculations or analyses takes place by means of algorithms, for example a random feature selection.

The other data ascertained, but not utilised any further, are used for statistical purposes or for later recording for the reconstruction of production errors or similar.

As another advantage of the invention, the calculation model is adapted from the measurements of the wall thicknesses of the lining 12 after a number of tappings by means of an analysis, for example a regression analysis, by means of which the wear can be calculated or simulated taking into account the collected and structured data. This adapted calculation model is also especially suitable for use for the purposes of testing, in order to test or simulate process sequences or to make specific changes.

The invention is sufficiently displayed by the exemplary embodiment described above. Needless to say it could also be realised by other variations.

Thus, the vessel 10 is provided on the side, in a way known in its own right, with at least one other outlet opening (not shown in any more detail), with which a special tap with a number of refractory sleeves lined up in a row is generally used. Needless to say, the state of this tap is also measured and ascertained and included in the calculation model according to the invention.

1. A method for determining the state of the refractory lining of a vessel containing the molten metal in particular, wherein data of this refractory lining (12), such as materials, wall thickness, type of installation and others are detected or measured and evaluated, characterised in that the following measured or established data of each vessel (10) are all collected and stored in a data structure, namely
the initial refractory construction of the inner vessel lining (12), such as materials, material properties, wall thicknesses of blocks and/or injected materials as maintenance data;
production data during use, such as amount of molten mass, temperature, composition of the molten mass or the slag and its thickness, tapping times, temperature profiles, treatment times and/or metallurgical parameters;
wall thicknesses of the lining after using a vessel (10), at least at points with the greatest degree of wear;
additional process parameters such as the manner of pouring or tapping the molten metal into or out of the vessel (10);
that a calculation model is generated from at least some of the measured or ascertained data or parameters, by means of which these data or parameters are evaluated by means of calculations and subsequent analyses.

2. The method according to claim 1, further comprising:
checking the data for plausibility after being recorded, and
when there is a lack or an anomaly of one or more values of the data, correcting the lack of one or more values of the data or deleting the anomaly of one or more values of the data.

3. The method according to claim 1, further comprising, after individually checking the data, storing the checked data as an assembled, valid set of data.

4. The method according to claim 1, further comprising selecting a reduced number from the measured or ascertained data or parameters for the recurring calculations or analyses dependent upon empirical values or by calculation methods.

5. The method according to claim 4, wherein the selection of measured or ascertained data or parameters for the recurring calculations or analyses takes place by means of algorithms, one of the algorithms being a random feature selection.

6. The method according to claim 4, the further comprising using other data that are not utilised any further for statistical purposes or for later recording of data.

7. The method according to claim 1, further comprising measuring the wall thicknesses of the lining after a number of tappings, on the basis of these measurements on the one hand this calculation model making a decision regarding further use with or without repairs of the vessel.

8. The method according to claim 1, further comprising adapting the calculation model from the measurements of the wall thicknesses of the lining after a number of tappings by means of an analysis by means of which the wear can be calculated taking into account the collected and structured data.

9. The method according to claim 8, wherein the model for this neural network is used for purposes of testing, in order to test or simulate process sequences from the model and in order to make specific changes in actual operation on this basis.

10. The method according to claim 1, wherein the metallurgical vessel is divided into different sections and this calculation model evaluates these sections independently of one another on the basis of all of the measured and ascertained data or parameters.

11. The method according to claim 10, further comprising selecting the sections on the one hand distributed over the circumference of the vessel and on the other hand over its height.

12. The method according to claim 8, wherein the analysis is a regression analysis.

13. The method according to claim 10, wherein the metallurgical vessel is a converter.

14. The method according to claim 2, further comprising, after individually checking the data, storing the checked data as an assembled, valid set of data.

15. The method according to claim 2, further comprising selecting a reduced number from the measured or ascertained data or parameters for the recurring calculations or analyses dependent upon empirical values or by calculation methods.

16. The method according to claim 2, wherein the metallurgical vessel is divided into different sections and this calculation model evaluates these sections independently of one another on the basis of all of the measured and ascertained data or parameters.

17. The method according to claim 16, further comprising selecting the sections on the one hand distributed over the circumference of the vessel and on the other hand over its height.

18. The method according to claim 3, further comprising adapting the calculation model from the measurements of the wall thicknesses of the lining after a number of tappings by means of an analysis by means of which the wear can be calculated taking into account the collected and structured data.

19. The method according to claim 3, further comprising selecting a reduced number from the measured or ascertained data or parameters for the recurring calculations or analyses dependent upon empirical values or by calculation methods.

20. The method according to claim 19, wherein the selection of measured or ascertained data or parameters for the recurring calculations or analyses takes place by means of algorithms, one of the algorithms being a random feature selection.
